(19) United States
(12) Patent Application Publication
(10) Pub. No.: US 2012/0167071 A1
(43) Pub. Date: Jun. 28, 2012

(54) SOFTWARE UPDATE APPARATUS AND METHOD OF VEHICLE

(75) Inventor: Jang Woon Paek, Daegu (KR)

(73) Assignee: Electronics and Telecommunications Research Institute, Daejeon (KR)

(21) Appl. No.: 13/284,274

(22) Filed: Oct. 28, 2011

(30) Foreign Application Priority Data
Dec. 22, 2010 (KR) 10-2010-0132909

(51) Int. Cl. G06F 9/44

(52) U.S. Cl. 717/170

(57) ABSTRACT

A software update apparatus of a vehicle includes: a network unit configured to perform internal communications with a plurality of electronic control devices inside the vehicle; a near field communication (NFC) module configured to wirelessly access a mobile communication terminal; and a client control unit configured to manage software versions of the electronic control devices collected through the network unit, provide the software version information to the mobile communication terminal through the NFC module, download software requiring update, transmits the downloaded software to the electronic control devices through the network unit, and receive an update state to transmit to the mobile communication terminal.

### CROSS-REFERENCES TO RELATED APPLICATIONS

The present application claims priority under 35 U.S.C 119(a) to Korean Application No. 10-2010-0132909, filed on Dec. 22, 2010 in the Korean intellectual property Office, which is incorporated herein by reference in its entirety set forth in full.

### BACKGROUND

Exemplary embodiments of the present invention relate to a software update apparatus and method of a vehicle, and more particularly, to a software update apparatus and method which accesses an update server through wireless Internet by using a mobile communication terminal having a Bluetooth module mounted therein, downloads software of electronic control devices inside the vehicle which are connected to an internal communication network of the vehicle, and updates the software of the electronic control devices inside the vehicle.

In general, a vehicle includes various electronic control devices such as an anti-lock brake system (ABS), a traction control system (TCS), an electronic stability program (ESP), an engine control system, a brake system, an airbag system and so on, which are used to improve stability and convenience of the vehicle.

Such electronic control devices have software installed therein, which is used for driving the respective systems. According to the software, the electronic control devices read information from various sensors or devices of the vehicle and perform their own control functions.

When the software is to be changed or updated into new software to improve the performance of the vehicle or prepare for a malfunction, a software recall is performed.

The above-described technology indicates the related art of the technical field to which the present invention pertains, and does not include the prior art.

In order to receive such a software recall service, a consumer should visit a designated software recall service place in person, and receive an update service for updating the software of the electronic control devices into new software.

### SUMMARY

An embodiment of the present invention relates to a software update apparatus and method which accesses an update server through wireless Internet by using a mobile communication terminal having a Bluetooth module mounted therein, downloads software of electronic control devices inside the vehicle which are connected to an internal communication network of the vehicle, and updates the software of the electronic control devices inside the vehicle.

In one embodiment, a software update apparatus of a vehicle includes: a network unit configured to perform internal communications with a plurality of electronic control devices inside the vehicle; a near field communication (NFC) module configured to wirelessly access a mobile communication terminal; and a client control unit configured to manage software versions of the electronic control devices collected through the network unit, provide the software version information to the mobile communication terminal through the NFC module, download software requiring update, transmits the downloaded software to the electronic control devices through the network unit, and receive an update state to transmit to the mobile communication terminal.

The network unit may perform the internal communications through one or more of a controller area network (CAN), a local interconnect network (LIN), FlexRay, and a media oriented systems transport (MOST) network.

The NFC module may include a Bluetooth module.

The mobile communication terminal may access the client control unit and the NFC module, transmits the software version information received from the client control unit to an update server, receive a list of software requiring update from the update server, download the software requiring update from the update server, and requests the client control unit to perform update.

The update server may include a database configured to store a software list and update information of the plurality of electronic control devices for each vehicle, compare the update information stored in the database with the software version information, and provide the list of software requiring update and the update information.

The mobile communication terminal and the update server may be connected through wireless internet.

The update server may further include a short message service (SMS) configured to transmit new update information to the mobile communication terminal through a text message.

The update server may further include a mail server configured to transmit new update information through a mail.

In another embodiment, a software update method of a vehicle includes: collecting software versions through internal communications with a plurality of electronic control devices according to a request of software version information of the electronic control devices from a mobile communication terminal, and transmitting the collected software version information to the mobile communication terminal; transmitting software transmitted in response to an update request of the mobile communication terminal to the electronic control devices, and performing update; and transmitting the update state to the mobile communication terminal, after the update is performed.

In another embodiment, a software update method of a vehicle includes: receiving software version information of a plurality of electronic control devices inside the vehicle from a software update apparatus; transmitting the software version information to an update server, receiving a list of software requiring update from the update server, and outputting the received list; requesting a download of software selected from the software list; transmitting the downloaded software to the software update apparatus, and requesting update; and receiving and outputting an update state, after requesting the update.

In another embodiment, a software update method of a vehicle includes: receiving software version information from a mobile communication terminal; comparing update information stored in a database with the received software version information, and transmitting a list of software requiring update; and when a download of software in the list of software requiring update is requested, transmitting corresponding update information to the mobile communication terminal.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram of a software update apparatus of a vehicle in accordance with an embodiment of the present invention;

FIG. 2 is a block configuration diagram illustrating a state in which the software update apparatus in accordance with the embodiment of the present invention is used; and

FIG. 3 is a flow chart explaining a software update method of a vehicle in accordance with another embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

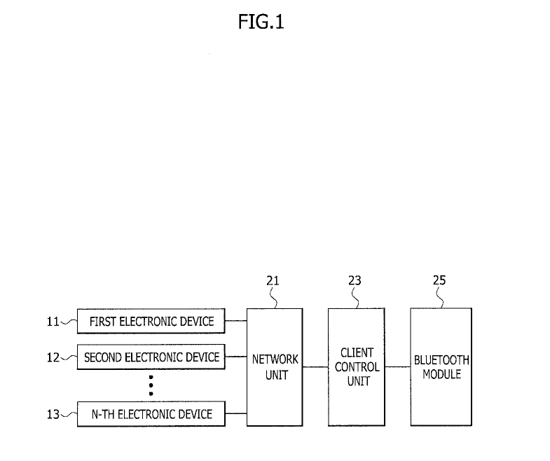

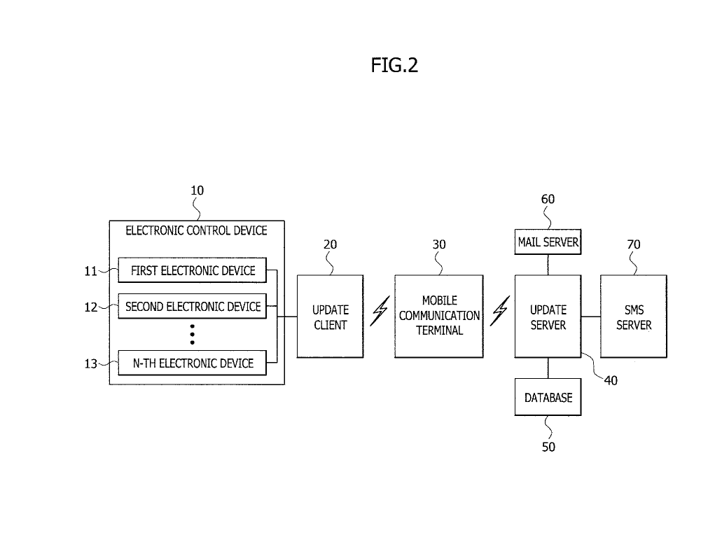

FIG. 1 is a block configuration diagram of a software update apparatus of a vehicle in accordance with an embodiment of the present invention. FIG. 2 is a block configuration diagram illustrating a state in which the software update apparatus in accordance with the embodiment of the present invention is used.

Referring to FIG. 1, the software update apparatus in accordance with the embodiment of the present invention includes a network unit 21, a Bluetooth module 25, and a client control unit 23.

The network unit 21 is configured to connect first to n-th electronic control devices 11 to 13 to internal communications such as a controller area network (CAN), a local interconnect network (LIN), FlexRay, and a media oriented systems transport (MOST) network, collect and manage the software versions of the respective electronic control devices, and provide the software version information.

At this time, the electronic control devices 10 may include an ABS, a TCS, an ESP, an engine system, a brake system, an airbag system and so on, which are used to improve the stability and convenience of the vehicle.

The Bluetooth module 25 is a near field communication (NFC) module for wirelessly accessing a mobile communication terminal 30.

The client control unit 23 is configured to manage the software versions of the plurality of electronic control devices 10, which are collected through the Bluetooth module 25 and the network unit 21, provide the software version information to the mobile communication terminal 30 through the Bluetooth module 25, download software requiring update, transmit the downloaded software to the plurality of electronic control devices 10 through the network unit 21, receive an update state to transmit to the mobile communication terminal 30, and perform an update operation.

Referring to FIG. 2, the software update apparatus 20 of the vehicle configured in such a manner is connected to the mobile communication terminal 30 and an update service 40 to update the software of the vehicle.

The mobile communication terminal 30 as a smart phone includes a Bluetooth module for NFC, and accesses the wireless Internet through WiFi or a mobile communication network and relays the software update apparatus 20 and the update server 40. At this time, the mobile communication terminal 30 communicates with the software update apparatus 20 through NFC and communicates with the update server 40 through the wireless Internet.

Such a mobile communication terminal 30 transmits the software version information received from the software update apparatus 20 to the update server 40, receives a list of software requiring update from the update server 40, displays the received software list, download software selected from the displayed list from the update server 40, requests the client control unit 23 of the software update apparatus 20 to perform an update operation, and receives an update state to display.

The update server 40 includes a database 50 storing the software list and update information of the plurality of electronic control devices 10 for each vehicle, compares the update information stored in the database 50 with the software version information, and provides a list of software requiring update and update information.

The update server 40 may further include a short message service (SMS) server for transmitting new update information to the mobile communication terminal 30 through a text message and a mail server 60 for transmitting new update information through a mail.

When the software update apparatus 20 configured such a manner provides the software version information of the plurality of electronic control devices 10 in response to a request of the mobile communication terminal 30, the software update apparatus 20 receives an update list as the list of software requiring update from the update server 40 through the mobile communication terminal 30, based on the software version information, requests the update server 40 to transmit update information of the selected software, and update the software of the electronic control devices 10 by using the transmitted update information.

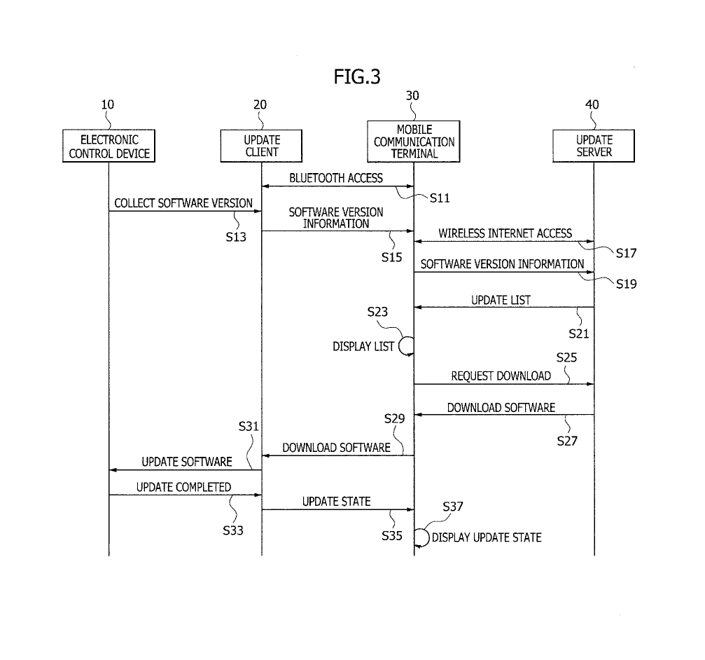

FIG. 3 is a flow chart explaining a software update method of a vehicle in accordance with another embodiment of the present invention.

First, referring to FIG. 3, the mobile communication terminal 30 accesses the software update apparatus 20 through the Bluetooth module 25 to update the software of the electronic control devices 10 inside the vehicle through the software update apparatus 20 at step S11.

At this time, when the mobile communication terminal 30 accesses the software update apparatus 20, the access may be performed only in case where user access is allowed for security.

When the mobile communication terminal 30 accesses the software update apparatus 20 in such a manner, the software update apparatus 20 collects software versions of the electronic control devices 10 in order for software update at step S13, and transmits the collected software version information to the mobile communication terminal 30 at step S15.

The mobile communication terminal 30 receiving the software version information accesses the update server 40 through the wireless Internet at step S17.

At this time, the access may be performed only in case where user access is allowed.

When the mobile communication terminal 30 and the update server 40 are connected in such a manner, the mobile communication terminal 30 transmits the received software version information of the electronic control devices 10 inside the vehicle to the update server 40 at step S19.

The update server 40 compares the update information of the electronic control devices 10 for each vehicle in the database 50 with the received version information of the electronic control devices 10, and transmits an update list of software requiring update to the mobile communication terminal 30 at step S21.

The mobile communication terminal 30 receiving the update list displays the update list through a graphical user interface (GUI) at step S23.

Then, the mobile communication terminal 30 requests the update server 40 to transmit software in the displayed update list, which is desired to be updated by a user, at step S25.

The update server 40 receiving a download request of software provides the update information of the software at step S27, and the mobile communication terminal 30 downloading the update information transmits update information to the software update apparatus 20 at step S29.

The software update apparatus 20 transmits the downloaded software to the electronic control devices 10 to perform software update at step S31.

Then, the software update apparatus 20 receives an update state indicating that the software update was completed, from the electronic control devices 10, and transmits the update state to the mobile communication terminal 30 at steps 33 and 35.

The mobile communication terminal 30 displays the received update state to inform a user that the software update was completed, at step S37.

Furthermore, such software update may be performed when new update information is stored in the update server 40 storing the software of the plurality of electronic control devices 10 for each vehicle. In this case, as the update server 40 informs a user of the new update information through an email and the mobile communication terminal 30 through the mail server 60 and the SMS sever 70, the software update may be performed through the mobile communication terminal 30.

In accordance with the embodiments of the present invention, the software of the electronic control devices inside the vehicle, which are connected to the internal communication networks of the vehicle, is downloaded through the update server connected to the mobile communication terminal having the Bluetooth mode mounted therein through the wireless Internet, and the software of the electronic control devices inside the vehicle may be easily updated.

Furthermore, as the software of the electronic control devices inside the vehicle is updated by using the Bluetooth communication using a free frequency band and the wireless Internet through WiFi or a mobile communication network, update may be performed without paying an additional service charge.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A software update apparatus of a vehicle, comprising:
a network unit configured to perform internal communications with a plurality of electronic control devices inside the vehicle;
a near field communication (NFC) module configured to wirelessly access a mobile communication terminal; and
a client control unit configured to manage software versions of the electronic control devices collected through the network unit, provide software version information to the mobile communication terminal through the NFC module, download software requiring update, transmits the downloaded software to the electronic control devices through the network unit, and receive an update state to transmit to the mobile communication terminal.

2. The software update apparatus of claim 1, wherein the network unit performs the internal communications through one or more of a controller area network (CAN), a local interconnect network (LIN), FlexRay, and a media oriented systems transport (MOST) network.

3. The software update apparatus of claim 1, wherein the NFC module comprises a Bluetooth module.

4. The software update apparatus of claim 1, wherein the mobile communication terminal accesses the client control unit through the NFC module, transmits the software version information received from the client control unit to an update server, receives a list of software requiring update from the update server, downloads the software requiring update from the update server, and requests the client control unit to perform update.

5. The software update apparatus of claim 4, wherein the update server comprises a database configured to store a software list and update information of the plurality of electronic control devices for each vehicle, compares the update information stored in the database with the software version information, and provides the list of software requiring update and the update information.

6. The software update apparatus of claim 4, wherein the mobile communication terminal and the update server are connected through wireless Internet.

7. The software update apparatus of claim 5, wherein the update server further comprises a short message service (SMS) configured to transmit new update information to the mobile communication terminal through a text message.

8. The software update apparatus of claim 5, wherein the update server further comprises a mail server configured to transmit new update information through a mail.

9. A software update method of a vehicle, comprising:
collecting software versions through internal communications with a plurality of electronic control devices according to a request of software version information of the electronic control devices from a mobile communication terminal, and transmitting the collected software version to the mobile communication terminal;
transmitting software transmitted in response to an update request of the mobile communication terminal to the electronic control devices, and performing update; and
transmitting the update state to the mobile communication terminal, after the update is performed.

10. A software update method of a vehicle, comprising:
receiving software version information of a plurality of electronic control devices of the vehicle from a software update apparatus;
transmitting the software version information to an update server, receiving a list of software requiring update from the update server, and outputting the received list;
requesting a download of software selected from the software list;
transmitting the downloaded software to the software update apparatus, and requesting update; and
receiving and outputting an update state, after requesting the update.

11. A software update method of a vehicle, comprising:
receiving software version information from a mobile communication terminal;
comparing update information stored in a database with the received software version information, and transmitting a list of software requiring update; and
when a download of software in the list of software requiring update is requested, transmitting corresponding update information to the mobile communication terminal.
